(19) United States
(12) Patent Application Publication
(10) Pub. No.: US 2009/0195710 A1
(43) Pub. Date: Aug. 6, 2009

(54) Electronic picture frame

(76) Inventor: Ling FANG, Guangdong Province (CN)

Correspondence Address: ERIC CHAN, 42 PIN OAKS DRIVE, PHOENIXVILLE, PA, 19460, US

(21) Appl. No.: 12/024,056

(22) Filed: Jan. 31, 2008

(51) Int. Cl. H04N 5/64

(52) U.S. Cl. 348/836; 348/E05.128

(57) ABSTRACT

An electronic picture frame relates to an electronic picture frame which can display and edit images and more particularly pertains to an electronic picture frame with multi-functions. The electronic picture frame comprises a microprocessor module; a storage module which connects to the microprocessor module and stores the programs to be run by the microprocessor module; a power supply management module which connects to the microprocessor module and the storage module; a display module which connects to the microprocessor module; a control module which comprises a plurality of function keys and connects to the microprocessor module; an input/output module which connects to the microprocessor module; wherein it further comprises a wireless network module which externally connects to network signals via a WAN interface, and the wireless network module connects to the microprocessor module. By adding a wireless network module which connects to the microprocessor module, the electronic picture frame of the present invention can provide a wireless network communication function in addition.

### BACKGROUND OF THE INVENTION

The present invention relates to an electronic picture frame which can display and edit images and more particularly pertains to an electronic picture frame with multi-functions.

In recent years, the functions of present digital products have become more advanced due to rapid growth in digital image technology. Taking the present digital cameras as an example, not only can they take images, but they also have the functions of recording videos and playing MP3s; moreover, they will soon be capable of transmitting data via wireless means. Since digital cameras have a number of advantages such as high pixels, high image resolution, multi-functions and convenience to use, they have become one of the most popular electronic products. After taking images with a digital camera, if a user wishes to view and edit images at the same time, the user has to transmit the image data stored in the memory card to a memory module of a computer, and then use the image processing software installed in the computer to edit the displaying images.

Moreover, various output applications which accompany computer editing applications have flourishing development, examples of which include compact discs recording, photos outputting, photo-stickers production and electronic picture frames. However, the electronic picture frames now present in the prior art only have the function of image display. The present invention therefore aims to provide a multi-functional electronic picture frame to strengthen the functions of electronic picture frames in the prior art and to satisfy consumers' needs.

### BRIEF SUMMARY OF THE INVENTION

The object of the present invention is to provide a multi-functional electronic picture frame.

To attain this, the present invention generally comprises an electronic picture frame which comprises:

a microprocessor module;

a storage module which connects to the microprocessor module and stores the programs to be run by the microprocessor module;

a power supply management module which connects to the microprocessor module and the storage module;

a display module which connects to the microprocessor module;

a control module which comprises a plurality of function keys and connects to the microprocessor module;

an input/output module which connects to the microprocessor module; wherein

it further comprises a wireless network module which externally connects to network signals via a WAN interface, and the wireless network module connects to the microprocessor module.

By adding a wireless network module which connects to the microprocessor module, the electronic picture frame of the present invention can additionally provide a wireless network communication function.

The present invention further comprises:

a bluetooth module which connects to the microprocessor module, and the bluetooth module can receive and emit data to achieve bilateral data transmission;

a video processing module which connects to the microprocessor module, and the video processing module connects to the display module;

a telephone signal conversion module which connects to the microprocessor module. The telephone signal conversion module can communicate with other products of the same category via telephone wires.

The addition of the bluetooth module, the telephone signal conversion module and the video processing module can achieve interprocess data reception and transmission and local video display functions respectively.

### BRIEF DESCRIPTION OF THE DRAWINGS

FIG. 1 is a block diagram illustrating the functional modules of the present invention.

FIG. 2 is the structural diagram of the present invention.

### DETAILED DESCRIPTION OF THE INVENTION

The present invention is further illustrated with the accompanying drawings and embodiments.

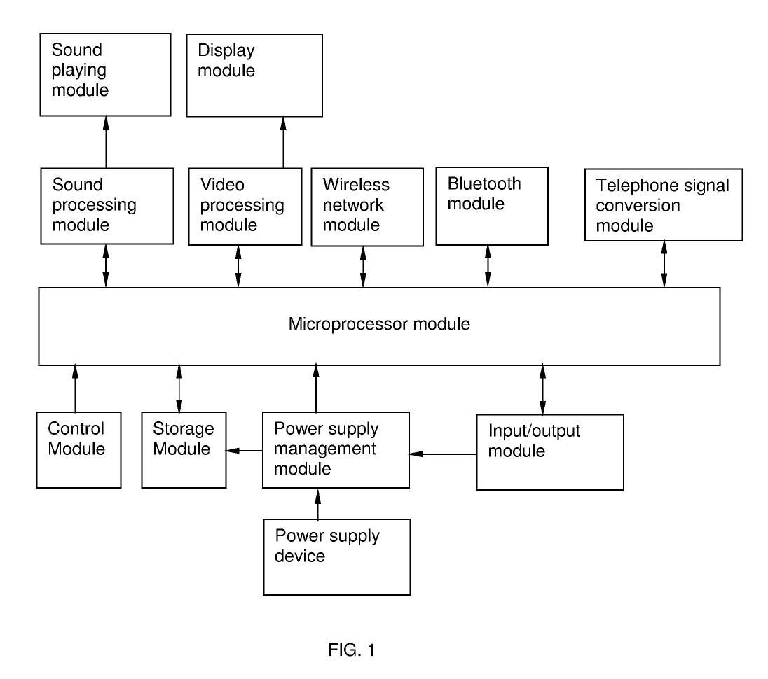

As illustrated in FIG. 1, the electronic picture frame comprises a microprocessor module;

a storage module which connects to the microprocessor module, wherein the storage module refers to a storage module in a broad sense which includes storage units which store programs to be run by the microprocessor module and storage units which store various files including audio and video files;

a power supply management module which connects to a plurality of modules including the microprocessor module, the storage module and an input/output module; the power supply means supply power to a plurality of modules including the microprocessor module, the storage module and the input/output module via the power supply management module respectively;

a display module which connects to the microprocessor module via a video processing module; the video processing module comprises a video processing unit and a sensor used to receive external video data and transmit the same to the microprocessor module; the electronic picture frame can thereby provide the dual functions of video data input and output;

a control module which comprises a plurality of function keys and connects to the microprocessor module; the input/output module which connects to the microprocessor module;

a sound processing module and a sound playing module, wherein the sound processing module bilaterally connects to the microprocessor module and records audio data through a microphone, and the sound processing module further connects to the sound playing module which is used to play music or other audio files;

a wireless network module which externally connects to network signals via a WAN interface, and the wireless network module connects to the microprocessor module to achieve wireless network communication;

a bluetooth module which connects to the microprocessor module, and the bluetooth module can receive and emit data to achieve bilateral data transmission;

a telephone signal conversion module which, upon receipt of a telephone ringing signal, processes and converts the signal via an internal interface of the telephone to a signal required by the microprocessor module, initiates the connection with the microprocessor module and communicates with other products of the same category via telephone wires.

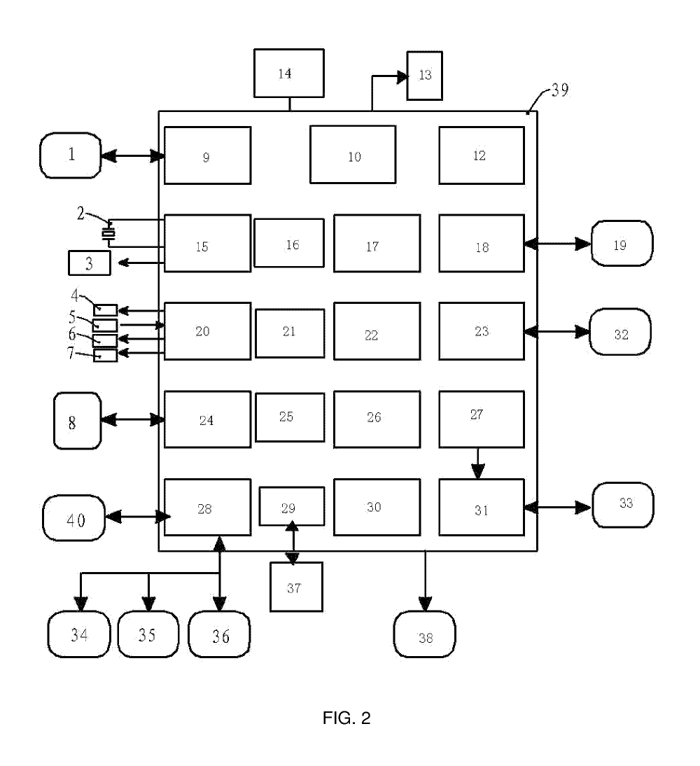

The detailed structure of the electronic photo frame is illustrated with the accompanying FIG. 2.

The microprocessor module 39 is internally disposed with a bus module 21 and an input/output port which can connect to a digital camera or a memory card, thereby carries out the transmission of images, texts and audio data, and transmits and stores the data obtained to any of the data storage modules of the expansion cards 34, 35, 36 connected thereto. A flash memory 40 stores the programs to be run by the microprocessor module 39. The flash memory 40 can be a synchronous dynamic RAM (SDRAM). The microprocessor module 39 is internally disposed with a phase-locked loop 16 which upwardly supports a system clock of 120 MHZ.

The control module 12 connects to the microprocessor module 39 so that a user can input editing commands to the microprocessor module 39 to edit images or texts.

By combining the video display function and the wireless network communication function, instant video communication can be achieved. In the instant video communication mode, when the electronic picture frame is not in operation for 10 minutes (no operation or no signals received), it will enter standby mode. In this mode, the microprocessor module 39 enters sleeping mode and the power consumption is less than 1 W. Upon signal activation or operation, the electronic picture frame automatically enters operating mode. Automatic power conservation is thereby achieved.

A data storage unit 28 reads the image and text data designated by a user and transmits the data to a video processing unit 23 which connects to the microprocessor module 39 for display processing, and then transmits the processed image and text data to a video display device 32. The video display device 32 can be a LCD monitor. When the microprocessor module 39 finished operation, the power supply management module stops supplying power to the microprocessor module 39 and the data storage unit 28.

The clock 2 generates standard and clock frequencies which are output to the microprocessor module 39 to function as the time source of the present invention after being calculated by the real time clock 15. The microphone 5 collects the sounds in the environment and reads the sound sources stored in the memory cards which, after being processed by an audio decoder 20, are restored as sounds by different means respectively in a left sound track 4, a loudspeaker 6 and an audio playing device 7. The microprocessor module 39 can process programs in the program storage module 1 via a DMA control device 9. A clock generator 10 generates a standard frequency for the synchronized operation of the microprocessor module 39 and the program storage module 1.

Furthermore, a user can set a time to play designated music with the microprocessor module 39. Similar to the aforementioned operation, the microprocessor module 39 reads the standard clock signal from the real time clock 15 at a preset time on a preset date, and then outputs the clock signal through the clock output 3. When all the required data has been obtained by reading the data stored in the expansion cards 34, 35, 36, the data is transmitted to the audio decoder 20 connected to the microprocessor module 39 for processing for audio playing. The processed audio data is then transmitted to the audio playing device 7 to play the music designated by the user. Rapid data transmission can be achieved by an asynchronous transceiver 12, and through which the user can also externally adjust the volume. A bluetooth module 8 can receive and emit data to achieve bilateral data transmission through the connection with the microprocessor module 39. By connecting the bluetooth module 8 to a digital audio interface 24, the microprocessor module 39 can process digital audio signals received. A termination control device 25 can control the termination request from the microprocessor module 39. The microprocessor module 39 can output S-video, YPbPr, NTSC, PAL and high definition TV (HDTV) through a video digital/analog converter 31. The wireless network module 14 of the electronic picture frame can receive network signals through a WAN interface to function as a wireless router. A telephone interface 37 connects to a wireless receiver 29 to convert telephone standard signals and is also controlled by the microprocessor module 39.

The electronic picture frame processes images from the sensor 19 through a MPEG-4 encoder 22. After being processed by a video processing unit 23, a JPEG decoder 26 and a picture processing module 17 of the microprocessor module 39, the original images are restored on the video display device 32. The driver has the capabilities of processing video signals such as RGB666 and VGA. Similarly, a sensor interface 18 and the sensor 19 can operate coordinately and can independently connect to a computer via a USB control device 30 and an external port. In other words, the sensor interface 18 and the sensor 19 can combine with the electronic picture frame to form a video conference system. At the same time, the sensor interface 18 and the sensor 19 can independently connect to a computer 38 to function as a USB camera and output video to a television 33 after being processed by a video encoder 27.

The multifunctional electronic picture frame can externally connects to USB devices such as a USB drive and MP3s via a USB control device 30. Meanwhile, by equipping with USB2.0, it can seamlessly connect to equipments having USBHOST function such as computer.

The switching of the aforementioned functions is implemented by software stored in the flash memory 40.

The present electronic picture frame can achieve flexible external connection by wireless networks, bluetooth and LAN 13 which connect to RJ45 and PHY chip.

What is claimed is:

1. An electronic picture frame which comprises:
a microprocessor module;
a storage module which connects to the microprocessor module and stores the programs to be run by the microprocessor module;
a power supply management module which connects to the microprocessor module and the storage module;
a display module which connects to the microprocessor module;
a control module which comprises a plurality of function keys and connects to the microprocessor module;
an input/output module which connects to the microprocessor module; wherein
it further comprises a wireless network module which externally connects to network signals via a WAN interface, and the wireless network module connects to the microprocessor module.

2. The electronic picture frame as in claim 1, wherein it further comprises a bluetooth module which connects to the microprocessor module, and the bluetooth module can receive and emit data.

3. The electronic picture frame as in claim 1, wherein it further comprises a video processing module which bilaterally connects to the microprocessor module, and the video processing module connects to the display module.

4. The electronic picture frame as in any of the claims 1 to 3, wherein it further comprises a telephone signal conversion module which connects to the microprocessor module.
